(19) United States
(12) Patent Application Publication
(10) Pub. No.: US 2005/0038589 A1
(43) Pub. Date: Feb. 17, 2005

(54) Method for estimating a friction coefficient

(76) Inventor: Deepak Shukla, Canton, MI (US)

Correspondence Address: Douglas A. Mullen;Dickinson Wright PLLC, Suite 800, 1901 L. Street NW, Washington, DC, 20036, US

(21) Appl. No.: 10/641,561

(22) Filed: Aug. 14, 2003

(51) Int. Cl. G06F 17/00

(52) U.S. Cl. 701/80; 73/105

(57) ABSTRACT

A method and a system for estimating a friction coefficient between a driven wheel and a surface. The method uses a Fourier series to calculate the friction coefficient. More specifically, a desired wheel slip ratio is calculated using received sensor readings related to a system state and a desired wheel speed determined from various system conditions or user inputs. A Fourier series is used to estimate the friction coefficient. The method is generally cycled many times each second to allow for varying road conditions by adjusting the Fourier series coefficients after each cycle. The system generally includes a wheel speed sensor and an accelerometer providing signals to a processor or various modules to perform the above method.

### BACKGROUND OF THE INVENTION

The present invention relates generally to a method of estimating a friction coefficient between a driven wheel and a surface and more specifically to a method of estimating the longitudinal friction force coefficient between a driven wheel and a surface.

The estimation of a friction coefficient between a driven wheel and a surface is important for a wide variety of applications including vehicle traction and stability control systems. These systems estimate the friction coefficient of a driven wheel to improve traction and handling characteristics of the vehicle. One problem with the current methods for estimating a friction coefficient is the difficulty in providing real time on-line estimation of the friction coefficient. Typically current methods rely on processing large amounts of past accumulated data and cannot be expected to quickly adapt to changes. Another problem with these methods is the amount of memory and computing power necessary to process the accumulated data. These problems are particularly acute for vehicles in which real time data regarding the friction coefficient is necessary to allow control systems to quickly respond to changing road conditions.

### SUMMARY OF THE INVENTION

The present invention is directed to a method and system for estimating the longitudinal friction force coefficient between a driven wheel and a surface. Although this application describes the current invention as being directed to vehicles, one skilled in the art should recognize the current invention has broader applications and may be used to determine the friction coefficient between any driven wheel and a surface. Examples of other applications include friction in mating parts (e.g. joints) of a machine or mechanism (e.g. a robot mechanism) or other devices where friction is of interest for operating or controlling that device.

The present invention uses a Fourier series to calculate a friction coefficient between a driven wheel and a surface. More specifically, a plurality of sensors provide data indicative of a system state to a processor which determines an estimated wheel speed, selects a desired wheel speed, and calculates a desired wheel slip ratio. A Fourier series is then used in conjunction with the desired wheel slip ratio to calculate the friction coefficient. A torque may then be applied to the driven wheel to reduce the difference between the actual wheel speed and the desired wheel speed. The Fourier series coefficients may then be adjusted and the cycle repeated until the actual wheel speed matches the desired wheel speed.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a schematic diagram of a vehicle including a friction estimation system 20 according to the present invention;

FIG. 2 is a flow chart outlining the method of the system including initialization of the Fourier series; and

FIG. 3 is a flow chart outlining the cycled method of the system.

### DETAILED DESCRIPTION

The present invention is generally directed to a friction estimation system and method that is capable of quickly, reliably and efficiently calculating a friction coefficient between a driven wheel and a surface. The system is described and illustrated herein as being incorporated into a vehicle for calculating the friction coefficient between a selected vehicle wheel and a surface. Notwithstanding this representative embodiment, it should be readily apparent that the system may be used in other contexts to determine the friction coefficient between any surface and a driven wheel or even the contact area in a rotatable joint. As used in vehicles, the system may readily use existing vehicle sensors, such as those commonly associated with anti-lock brake systems, traction control systems, or vehicle stability control systems, as indicators of a vehicle travel state. The sensor signals may be communicated to a system processor 30, or any other suitable control unit known in the art, to determine an estimated vehicle velocity. The processor 30 determines a desired vehicle velocity, a desired vehicle wheel speed, and a desired wheel slip ratio. The processor 30 is configured to use a Fourier series to calculate the friction coefficient of the driven wheel based on the desired wheel slip ratio. The method preferably cycles as many times as needed in a given time period, typically many times a second, to provide real time data regarding the friction coefficient in response to changing road conditions. The Fourier series coefficients may be adjusted each cycle to improve the accuracy of the estimation and adapt to any changes.

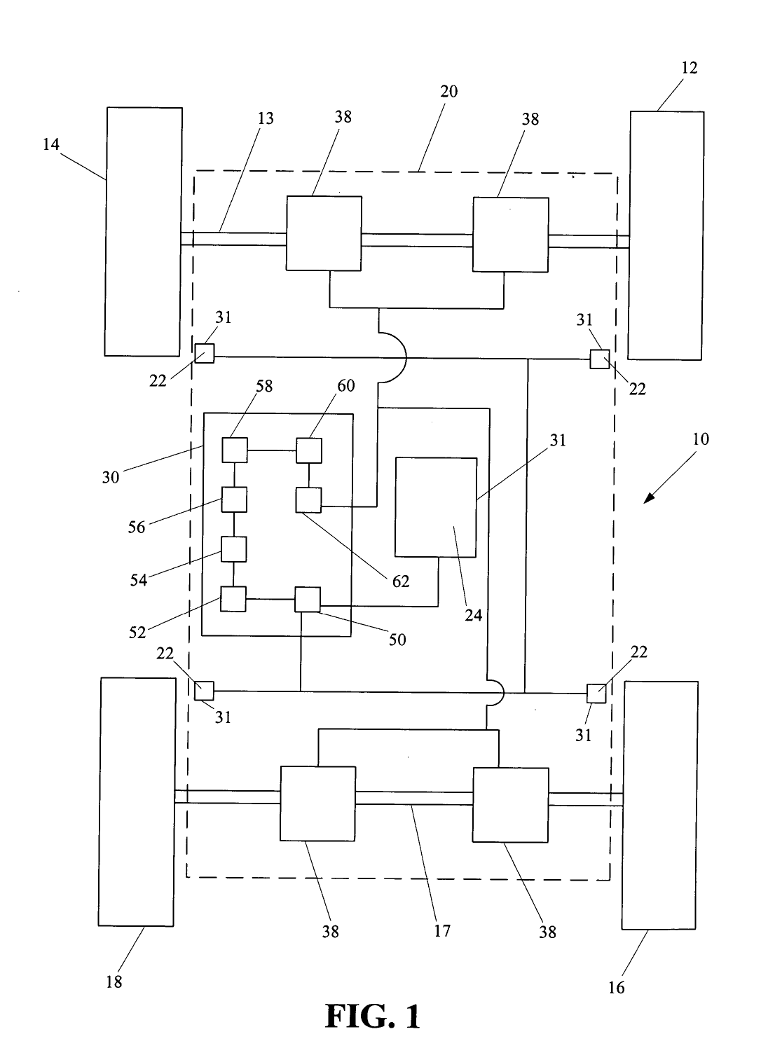

For ease of explanation, a vehicle 10 is shown schematically illustrated in FIG. 1 to include a front right wheel 12, a front left wheel 14, a rear right wheel 16, and a rear left wheel 18. The vehicle also includes the friction estimation system 20 which generally includes the processor 30, vehicle sensors 31, and a torque mechanism 38, such as electric motors, capable of applying or adjusting the torque on a given wheel. The processor 30 may be a conventional microprocessor having various modules communicating with vehicle sensors 31 and configured to calculate vehicle states, such as actual wheel speed, acceleration, and normal force on a given wheel. The processor 30 also includes modules to calculate a desired wheel slip ratio, the friction coefficient, the Fourier series coefficients and a torque to be applied to a selected wheel with the torque mechanism 38.

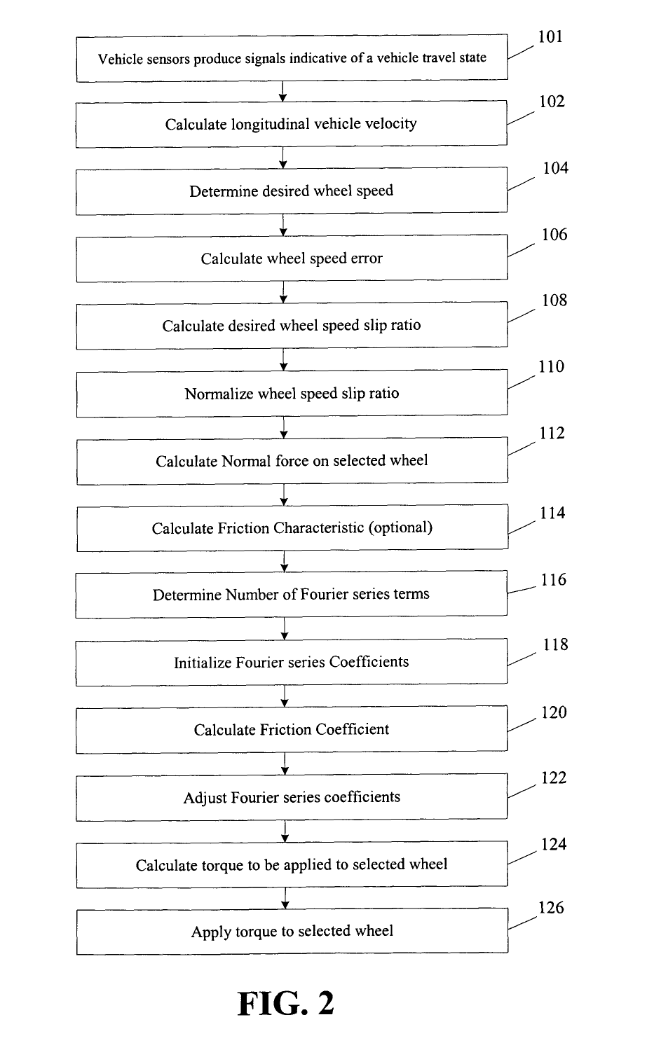

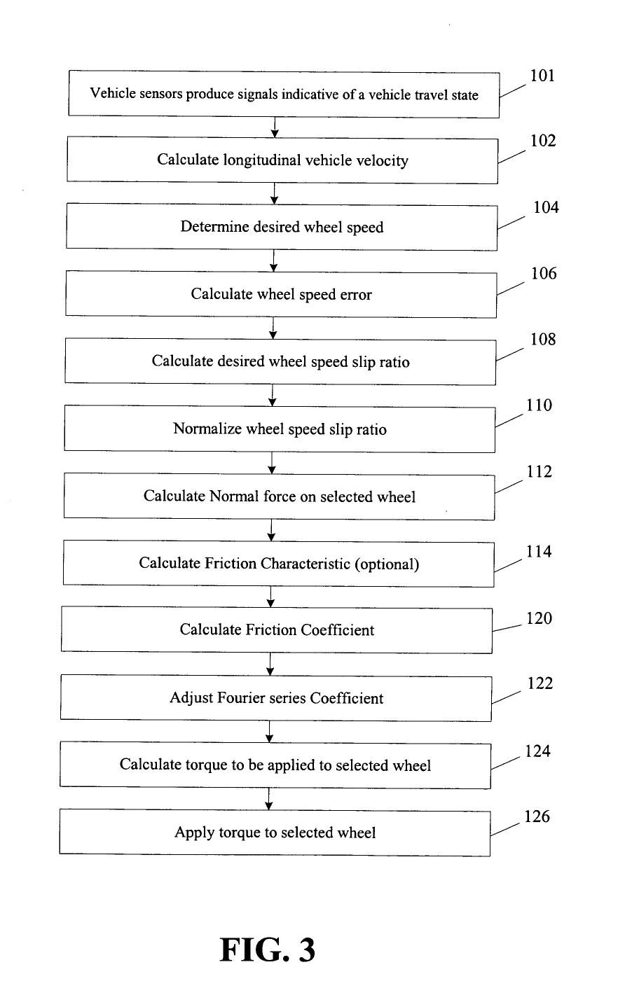

The system and method of the present invention will now be described in greater detail with reference to the vehicle schematic shown in FIG. 1 as well as the flow charts illustrated in FIGS. 2 and 3. As noted above, FIG. 2 shows the preferred steps performed by the processor 30 beginning with receipt of vehicle sensor signals indicative of a vehicle travel state (Step 101) through the application of torque to the selected wheel (Step 126). FIG. 3 illustrates representative processor steps performed during the repeated or cycled portion of the system and method, generally including the same steps as shown in FIG. 2, except for determining the number of Fourier series terms (Step 116) and initializing the series coefficients (Step 118). These calculation and initialization steps (Steps 116 and 118) are not included in the cycled method because the number of Fourier series terms is generally set during the first cycle and the coefficients are adjusted (Step 122) instead of being initialized during any repeat cycle. The following description of the system 20 and method refers to a plurality of modules within the processor. Those skilled in the art will appreciate that the description of the modules are provided in large part for ease of explanation and the system and method may be implemented through the use of any of the number of processing techniques, including hardware or software implemented structures, generally known in the art.

Vehicle sensors 31 provide data signals indicative of the motion of the vehicle (i.e., vehicle or system state) such as vehicle velocity or vehicle acceleration (Step 101, FIGS. 2 and 3). In the illustrated embodiment, the vehicle sensors 31 include a wheel speed sensor 22 and an accelerometer 24. Wheel speed sensors 22 are well known components of anti-lock brake systems, traction control systems, and vehicle stability control systems. Wheel speed sensors 22 typically count the number of times a wheel rotates by measuring how many times a magnet rotates past a magnetic sensor. The wheel angular velocity may be determined from the wheel speed sensor 22 by counting the number of rotations of the wheel in a given time period. Accelerometers 24 are commonly used in vehicle stability control systems to measure changes in linear velocity. Two accelerometers may be used, one measuring longitudinal acceleration and the other measuring lateral acceleration. In the illustrated embodiment, the accelerometer or accelerometers 24 provide a lateral acceleration signal and a longitudinal acceleration signal to a first processor module 50. The lateral signal provides information on velocity changes in the lateral direction, such as during turning of the vehicle, and the longitudinal signal provides information on velocity changes in the longitudinal direction, such as during acceleration or braking.

Vehicle parameters, such as wheel radius and combined inertia of the wheel motor shaft and connected drive train are known and may be stored in processor memory or in the memory of a particular processor module. From the wheel angular velocity, vehicle acceleration and the known radius of the wheel, the longitudinal velocity of the vehicle may be calculated (Step 102). This calculation may be performed by the first module processor 50 or an independent circuit board. Of course, any other known techniques for calculating the longitudinal velocity or actual wheel speed of the vehicle may be used. Examples of these techniques include using an average of the undriven wheel speeds, or a GPS informational system. Longitudinal acceleration may also be calculated for vehicles without accelerometers by measuring the change in a vehicle's longitudinal velocity over a specified period.

With the actual wheel speed known, a second processor module 52 may determine a desired vehicle wheel speed (Step 104) by a number of techniques. In the illustrated embodiment, the second module 52 determines the desired wheel speed (Step 104) based on vehicle operating parameters or vehicle operating states. For example, if it is desired to have the vehicle accelerate to a certain speed, the desired wheel speed is the wheel angular velocity corresponding to that desired vehicle speed. The desired wheel speed may be bounded to prevent excessive wheel slip. For example, to prevent the wheel from slipping while reaching the desired wheel speed, it may be necessary to determine intermediate desired wheel speeds. Each intermediate desired wheel speed is then used as the desired wheel speed and once reached, the system uses the next intermediate desired wheel speed until the actual wheel speed is close enough to the final desired wheel speed that intermediate desired wheel speeds are no longer needed to prevent the tires from slipping. Whenever possible, the present invention attempts to avoid any wheel slippage to prevent loss of vehicle performance or a delay in the time necessary to reach the desired wheel speed.

In some applications, it may be desirable to turn one wheel faster than others to correct a vehicle's yaw rate. In this instance, the processor would calculate or select a desired wheel speed for the target wheel that is slightly faster or slower than that of the opposing wheel. For example, the desired wheel speed may be calculated using a functional relationship or a look-up table containing the yaw rate or steering angle to correct a vehicle's current yaw rate. The determination of the desired vehicle wheel speed depends on the desired vehicle operating characteristics such as the exemplary methods outlined above, and the method of determining the desired wheel speed is not a principle focus of the present invention.

With the desired wheel speed determined, the processor 30, e.g., the second module 52, may calculate the wheel speed error (Step 106), which is the difference between the desired vehicle wheel speed and the actual vehicle wheel speed. The wheel speed error (e) may be calculated with the following equation:
e=ω_{d}−ω (1)
where ω_{d} is the desired wheel speed and ω is the measured or actual wheel speed.

The processor 30 may then calculate a wheel speed slip ratio (Step 108) such as via a third module 54. The wheel speed slip ratio is the relative wheel slip between the surface and the point of contact on the wheel with the surface. More specifically, the wheel longitudinal slip ratio is the slip speed of the wheel contact point with respect to the surface divided by the rim velocity of the wheel and may be calculated with the following equation:

$$λ = \frac{ω R - {v}_{x}}{ω R} \qquad ( 2 )$$

where (λ) is the wheel speed slip ratio, (ω) is the actual wheel speed, (R) is the radius of the wheel and (vₓ) is the longitudinal velocity of the vehicle's center of gravity. As discussed above, the radius of the wheel (R) is known and the longitudinal velocity of the vehicle (vₓ) is determined using known estimation techniques as described above.

In the illustrated embodiment, to reduce or eliminate the effect of sensor noise and resulting estimation errors, the processor 30 (e.g., third module 54) calculates a desired wheel speed based slip ratio (λ_{d}) in place of the actual wheel speed based slip ratio (λ). The third module may ensure that the desired wheel speed (ω_{d}) is close enough to the actual wheel speed (ω) so that very little error is introduced by substituting the desired wheel speed for the actual wheel speed. Therefore, Equation (2) becomes:

$${λ}_{d} = \frac{{ω}_{d} R - {v}_{x}}{{ω}_{d} R} \qquad ( 3 )$$

where (λ_{d}) is the desired wheel speed based longitudinal slip ratio, (ω_{d}) is the desired wheel speed, (R) is the radius of the wheel and (vₓ) is the longitudinal velocity of the vehicle's center of gravity.

One advantage from using the desired wheel speed (ω_{d}) in computing the wheel speed slip ratio is that the desired wheel speed is immune to many of the sensor noises found in the wheel speed sensor signal. The processor 30 normalizes the desired wheel slip ratio to constrain the normalized slip ratio to lie between 0 and 2π, to match the input range of the argument of the harmonic functions (Step 110). The normalized longitudinal wheel slip ratio is defined as:

$${λ}_{d , N} = 2 π ( \frac{{λ}_{d} - {λ}_{d , min}}{{λ}_{d , max} - {λ}_{d , min}} ) \qquad ( 4 )$$

where λ_{d,min} and λ_{d,max} are anticipated minimum and maximum values of λ_{d}. These values may be chosen as 0 for λ_{d,min} which represents no slip and 1 for λ_{d,max} which represents 100% slip.

In Step 112, the processor 30, or a fourth module 56, calculates the normal force (F_{z}) on a selected wheel. The normal force (F_{z}) is the force exerted by a surface on the wheel, in a direction normal to the surface, and in general consists of a dynamic force component and a static load component, on a wheel. The normal force may also be referred to as the total load on a wheel. When a vehicle is at rest, the normal force (F_{z}) for each wheel is generally the static load, determined by vehicle weight and location of its center of gravity with respect to wheel locations. As the vehicle is driven within various parameters and conditions, such as acceleration or turning, the normal force (F_{z}) on each wheel may vary due to dynamic load transfer. Dynamic load transfer is the load that is transferred from one wheel to the other during various vehicle operations. The dynamic load on each axle may be determined by the following equations:

$$\begin{matrix}{F}_{zf} = W \frac{c}{L} - W \frac{aH}{gL} & ( 5 ) \\ {F}_{zr} = W ( 1 - \frac{c}{L} ) + W \frac{aH}{gL} & ( 6 )\end{matrix}$$

where F_{zf} is the normal force on the front axle 13 and F_{zr} is the normal force on the rear axle 17. The remaining variables stand for the other vehicle parameters such as vehicle weight (W), distance of vehicle center of gravity from rear axle (c), vehicle acceleration (a), height of center of gravity above the ground (H), acceleration due to gravity (g), and vehicle wheelbase (L). The normal force (F_{z}) on each wheel can be calculated from the normal force on each axle. Equations (7)-(10) may be used to calculate the normal force (F_{z}) of each wheel where F_{zFL} is the normal force on the front left wheel 14, F_{zFR} is the normal force on the front right wheel 12, F_{zRL} is the normal force on the left rear wheel 18, and F_{zRR} is the normal force on the right rear wheel 16.

$$\begin{matrix}{F}_{zFL} = {F}_{zf} \frac{d}{t} + \frac{W}{g} \frac{c}{L} \frac{H}{t} {a}_{y} & ( 7 ) \\ {F}_{zFR} = {F}_{zf} ( 1 - \frac{d}{t} ) - \frac{W}{g} \frac{c}{L} \frac{H}{t} {a}_{y} & ( 8 ) \\ {F}_{zRL} = {F}_{zr} \frac{d}{t} + \frac{W}{g} ( 1 - \frac{c}{L} ) \frac{H}{t} {a}_{y} & ( 9 ) \\ {F}_{zRR} = {F}_{zr} ( 1 - \frac{d}{t} ) - \frac{W}{g} ( 1 - \frac{c}{L} ) \frac{H}{t} {a}_{y} & ( 10 )\end{matrix}$$

Equations (7)-(10) use various known parameters such as the lateral distance between the center of gravity and the wheel on the right side for that particular axle (d), vehicle track width (t), and vehicle lateral acceleration (a_{y}).

Equations (7)-(10) take into account the effect of longitudinal and lateral load transfer during acceleration and braking as well as turning or side slipping. When the vehicle is turned, the normal force on the wheels will be different for the wheels on the inside of the turn as compared to the wheels on the outside of the turn. However, for simplicity of illustrating the method of calculating a friction coefficient in the example below, this description assumes the vehicle is operating in a straight line. It should be readily recognized that using the simplified calculations for the normal force will not affect the method of the present invention, but only the accuracy of the friction coefficient by a small amount. Further, this simplification assumption is not a required component of the invention as one skilled in the art will readily recognize that the system and method of the present invention may be implemented without the assumption.

The processor 30 may calculate the friction characteristic λ(λ) through a fifth processor module 58 (Step 114). The friction characteristic μ(λ) is the co-adhesion coefficient between a given wheel and the ground and may be defined as the ratio of the longitudinal force (Fₓ) to the normal force (F_{z}) on the wheel.

$$μ ( λ ) = \frac{{F}_{x}}{{F}_{z}} \qquad ( 11 )$$

The friction characteristic μ(λ) between two surfaces is generally known to be bounded and normally does not exceed a value of 1. The peak friction coefficient between tire and road is almost always less than one except in very rare cases where it may go as high as 1.2, as is well known in the art. In the illustrated embodiment, the friction characteristic is not calculated (Step 114), because the system learns and therefore calculates the friction coefficient (Step 120) without calculating the friction characteristic (Step 114).

The next several paragraphs of this description describe the calculation of the friction coefficient using a Fourier series (Step 120 in FIGS. 2 and 3) including the calculation of the number of Fourier series terms and initialization of the coefficients (Steps 116 and 118 in FIG. 2). As noted above, once calculated, the number of terms generally stays constant and the coefficients are adjusted (Step 122) each cycle to improve accuracy and adapt to changing road conditions.

The processor 30 may include a sixth module 60 for calculating the friction coefficient using a Fourier series (Step 120). A Fourier series uses a summation of a set number of harmonic terms to converge on the correct value. In the illustrated embodiment, the following Fourier series equation may be used to calculate the friction coefficient:

$${μ}_{d} \approx {a}_{0} + {\sum }_{j = 1}^{n} {a}_{j} Sin ( j {λ}_{d , N} ) \qquad ( 12 )$$

In Equation (12), μ_{d} represents the calculated friction coefficient based on the desired wheel speed, aₒ and aⱼ are the coefficients typically associated with Fourier series. The approximate equality sign in above equation is used to take into account a small modeling error while using a finite number of terms (n) of Fourier series, (i) is the index or coefficient number, and (λ_{d,N}) is the normalized desired wheel speed based slip ratio defined earlier in Equation 4. The modeling error may be determined, if desired, through well known techniques of calculating the error associated with a Fourier series representation of a function.

One advantage of the use of a Fourier series in the present invention is that the series is a mathematically complete set of orthogonal functions that can approximate any well behaved function. Unlike conventional techniques for estimating, determining, or calculating the friction characteristic, the use of a Fourier series beneficially provides real time estimation not based on past data. FIG. 2 illustrates an initial method cycle performed before the friction coefficient is calculated. In this initial cycle, the processor 30, e.g., a sixth module 60, determines the number of Fourier series harmonic terms (Step 1116). The present invention uses the minimum number of terms necessary for the desired accuracy. As additional terms are added to the Fourier series, the accuracy of the equation is improved, but each additional term improves the accuracy by a smaller amount and therefore as terms are added. Eventually benefits resulting from an improvement in the accuracy of the estimation are lessened by the noise inherent in the sensors. Limiting the number of terms minimizes the computational power needed to accomplish the method of the current invention, lowers the cost to implement the present invention, and allows more calculations in a given time period. The present invention preferably uses ten to twenty terms. The number of terms is chosen by the desired accuracy of the estimated friction coefficient. The number of terms may be based on real world tests that determine the optimal number of terms under specific operating conditions or may be functionally related to the noise inherent in the sensors. After the number of terms is determined, the coefficients aₒ and aⱼ's from Equation (12) are initialized (Step 118) in the initial method cycle of FIG. 2. In Equation (12), coefficients a₀ and aⱼ's are adjusted or updated with each cycle of the method. When initializing the coefficients, they are preferably given values that correspond to the current vehicle operating conditions, although any value may be used. For example, the processor 30 (e.g., sixth module 60) may refer to a stored look-up table containing initial coefficient values which are preferably determined during testing for a specific vehicle. It should be readily recognized that because the system learns from previous calculations, the initial coefficients may vary. The closer the initial value is to the correct value, the quicker the system 20 provides an accurate estimation of the friction coefficient. Therefore, the processor 30 may use multiple look-up tables, each associated with specified vehicle states, to allow a more accurate estimation of the friction during the initial method cycle. The selected initial coefficients are generally used each time for the initial cycle which may be only when the car is started, or whenever the processor 30 is reset such as after a set number of cycles, or when the processor detects one of the values is outside the bounded ranges. As described above, the friction coefficient between a tire and the road is not expected to exceed a certain value for all known combinations of the tire and surfaces. The upper bounds of the friction characteristic, determined during testing, allow a quick and easy check to ensure the friction coefficient is within a specified range. After the Fourier series coefficients are initialized, the friction coefficient may be calculated as described above in Step 120. After calculation of the friction coefficient, the Fourier series coefficients may be adjusted or updated (Step 122), such as through the use of wheel speed error, to provide a more accurate estimation of the friction coefficient when the cycle is repeated. Other methods of adjusting Fourier series coefficients may also be used to improve estimation of the friction coefficient. The continual adjustment of the coefficients before each cycle allows the error in the friction coefficient to be minimized. To adjust the Fourier series coefficients, the following Euler integration technique may be used:
a_{j,new}=a_{j,old}+\hat{\dot{a}}ⱼ*Tₛ (13)
where Tₛ is the sample time, \hat{\dot{a}}ⱼ is the rate of change for the coefficients, a_{j,old} is the coefficient from the last cycle, and a_{j,new} is the new Fourier series coefficient. The sixth processor module 60 may use the following equation to determine the rate of change \hat{\dot{a}}ⱼ for the coefficients:
   \hat{\dot{a}}ⱼξⱼRF_{z} Sin(jλ_{d,N})e (14)
   where (i) is the index of the harmonic term with which the coefficient is associated, (ξ) is a chosen constant learning rate normally selected to control the change in coefficient value at each computation step, (R) is the radius of the wheel, (F_{z}) is the normal force on specific wheel, and (e) is the wheel speed error.

In the illustrated embodiment, the sample time is generally 5-20 ms, corresponding to cycle rate of about 50-200 Hz. However, the sample time and cycle rate may vary. The system 20 may be integrated into current vehicle control systems which generally have a 50 Hz or 140 Hz cycle rate. The estimation methodology described above is generally tied to the actual wheel speed reaching the desired wheel speed and therefore the performance of the estimation is generally tied to performance of a wheel speed controller 62, as discussed below. The coefficients may be frozen once the difference between the actual wheel speed and desired wheel speed falls below a specified value. The specified value may be set to any selected difference between the desired and actual wheel speeds depending on the desired accuracy of the friction coefficients. By freezing the coefficients, the calculations are made simpler thereby allowing more cycles in a given time period, or additional computational tasks, as needed.

Once the Fourier series coefficients are determined, the system calculates a torque to be applied to the wheel, such as in the manner described below (Step 124) and communicates a torque signal to the appropriate torque mechanism 38 for application of the torque to the wheel (Step 126). The processor 30 is shown to include a feedback adaptive wheel speed controller 62 to allow the processor to learn from changes in the dynamics of a system, such as varying road conditions. In the illustrated embodiment, the speed controller 62 calculates the torque to be applied (Step 124) to the selected wheel as follows:
T=I\dot{ω}_{d}+RF_{z}\hat{μ}_{d}(λ_{d})+K₁e+K₂ρ²e (15)
where: (I) is the combined inertia of the wheel and attached drive train; (K₁) and (K₂) are constant gains of the controller; and (ρ) is a controller gain that is higher than the maximum anticipated friction coefficient value to ensure proper controller performance. In the illustrated embodiment, a constant value of 1.2 for this controller gain may suffice, although other values may be used. The gains K₁ and K₂ can be chosen to be as high as the torque mechanisms may support without saturation and without exciting any unwanted behavior such as noise and vibration. Before the cycle is repeated in the manner illustrated in FIG. 3, the torque mechanism 38 is signaled to apply the torque calculated in Equation (15) to the wheel (Step 126) so as to reduce the difference between the actual and desired wheel speeds. The torque mechanism 38 may be of any conventional design including an electric motor attached to a wheel, a braking system, a clutch attached to the wheel to selectively apply a specified torque or to transfer a torque to a fly wheel. It should be readily recognized that virtually any mechanism that allows a set amount of torque to be applied to the selected wheel may be used. The cycle may then be repeated using the above described method, as shown in FIG. 3.

The remaining paragraphs of this specification set forth a representative calculation for determining the friction coefficient. Those skilled in the art will appreciate that the example is provided for illustration only. The numbers used to calculate the friction coefficient are randomly picked and do not necessarily represent any real world results. In this example, the wheel speed (ω) provided by the wheel speed sensor is 10 rad/s and the desired wheel speed (ω_{d}) is 15 rad/s at the initial time (at t=0). The wheel speed error may then be calculated to be 5 rad/s, as shown below.
e=ω_{d}−ω=15−10=5 rad/s (1)

The processor 30 receives data pertaining to various vehicle states from the vehicle sensors. For ease of calculation, in this example only, the vehicle is assumed to be in a straight line motion. Therefore, the yaw rate is zero (r=0) and the lateral acceleration (a_{y}) is zero (a_{y}=0 m/s²). The vehicle used in this example is accelerating with a longitudinal acceleration (aₓ) of 0.1 g, where g is acceleration due to gravity (g=9.8 m/s²).

In Step 102, the processor 30 estimates or determines the vehicle speed (vₓ) using the wheel speed sensors in a conventional manner. For purposes of this example, the vehicle speed is 4 m/s. The desired wheel speed cod is determined as described in Step 104 but for the purposes of this example is assumed to be 15 revolutions per second. Using the desired wheel speed ω_{d}, the processor 30 calculates the desired wheel speed slip ratio (λ_{d}) using Equation (3) (Step 108). The wheel radius (R) of the vehicle is known to be 0.3 m.

$$\begin{matrix}{λ}_{d} = \frac{{ω}_{d} R - {v}_{x}}{{ω}_{d} R} \\ {λ}_{d} = ( 15 * 0.3 - 4 ) / ( 15 * 0.3 ) = 0.11\end{matrix} \qquad ( 3 )$$

The processor 30 normalizes the desired wheel speed slip ratio (λ_{d,N}) in Step 110 using equation (4). As described above, for the purposes of this calculation, λ_{d,max} is assumed to be 1 and λ_{d,min} is assumed to be zero.

$$\begin{matrix}{λ}_{d , N} = 2 π ( \frac{{λ}_{d} - {λ}_{d , min}}{{λ}_{d , max} - {λ}_{d , min}} ) \\ {λ}_{d , N} = 2 * π * ( 0.11 - 0 ) / ( 1 - 0 ) = 0.22 π = 0.6912\end{matrix} \qquad ( 4 )$$

Once the normalized desired wheel speed slip ratio λ_{d,N} is calculated, the processor 30 determines normal force F_{z} on the wheel (Step 112) is determined for which the friction coefficient is to be calculated. In this example, the friction coefficient of the right rear wheel 16 is determined. Therefore, the normal force F_{zRR} on the right rear wheel 16 must be determined. Because the vehicle is accelerating, the normal force F on each rear wheel 16 and 18 is the static load for that wheel plus the weight transfer from the front wheels to the rear during acceleration. Because the vehicle, in this example, is traveling longitudinally without any lateral acceleration (a_{y}), the normal force on the left and right rear wheels are equal.

The calculated normal force on the right rear wheel includes both the static load and dynamic load. First the load on the rear axle is determined using Equation (6) from above;

$${F}_{zr} = W ( 1 - \frac{c}{L} ) + W \frac{aH}{gL} \qquad ( 6 )$$

then the load on one rear wheel is half the load on rear axle and inserting the exemplary coefficients, is determined as:

$${F}_{zr} = \frac{1200}{2} ( 1 - 0.55 ) + \frac{1200}{2} ( .2 ) ( .1 )$$

$$F = 270 + 12 = 282 Kg$$

where 1200 Kg is an exemplary vehicle weight, 0.55 meters is the distance from the front of the rear axle to the center of gravity for the vehicle, 0.2 is the ratio of the height of center of gravity (H) over the wheelbase (L), and 0.1 is the ratio of

$$( \frac{a}{g} ) .$$

The weight may be converted to Newtons by multiplying by (g) as follows:
282 Kg*9.8 m/s=2763.6 N (on each rear wheel)

Next, the processor calculates the friction coefficient (Step 120) using Equation (12) after determining the number of Fourier series terms and the initial coefficients.

$${\hat{μ}}_{d} = {\hat{a}}_{0} + {\sum }_{j = 1}^{n} {\hat{a}}_{j} Sin ( {jλ}_{d , N} ) \qquad ( 12 )$$

For simplicity of calculation, the example only uses six harmonic terms, but as discussed above any number can be used, with the preferred embodiment using ten to twenty harmonic terms. Using n=5 (i.e. 5+1=6 terms in the Fourier series), the Fourier series based friction coefficient estimation from Equation (12) can be rewritten as:
\hat{μ}_{d}=â₀+â₁ Sin(1λ_{d,N})+â₂ Sin(2λ_{d,N})+â₃ Sin(3λ_{d,N})+â₄ Sin(4λ_{d,N})+â₅ Sin(5λ_{d,N})
For simplicity of calculation and to show the updated process, the initial coefficients for the Fourier series are set to zero, although any other value could be used, and most likely the coefficients would come from a look-up table having values determined during real world testing.
â₀=0,â₁=0,â₂=0,â₃=0,â₄=0,â₅=0
These coefficients provide a friction coefficient of zero, which is obviously not accurate. Because the system learns from past mistakes, the processor 30 determines the rate of change of the coefficients using Equation (14) so that the system during the next cycle may provide an accurate estimation of the friction coefficient.

$${\dot{\hat{a}}}_{j} = {ζ}_{j} {r}_{w} {F}_{z} Sin ( {jλ}_{d , N} ) ⅇ \qquad ( 14 )$$

Inputting the numbers for each coefficient provides the following equations for the rate of change of each coefficient.

$${\dot{\hat{a}}}_{0} = {ζ}_{0} {r}_{w} {F}_{zw} ⅇ = ( 0.001 ) * ( 0.3 ) * ( 2763.6 ) * 5 = 4.1454$$

$${\dot{\hat{a}}}_{1} = {ζ}_{1} r {F}_{z} Sin ( 1 {λ}_{d , N} ) ⅇ = ( 0.001 ) * ( 0.3 ) * ( 2763.6 ) * 0.6374 * 5 = 2.6423$$

$${\dot{\hat{a}}}_{2} = {ζ}_{2} r {F}_{z} Sin ( 2 {λ}_{d , N} ) ⅇ = ( 0.001 ) * ( 0.3 ) * ( 2763.6 ) * 0.9823 * 5 = 4.0720$$

$${\dot{\hat{a}}}_{3} = {ζ}_{3} r {F}_{z} Sin ( 1 {λ}_{d , N} ) ⅇ = ( 0.001 ) * ( 0.3 ) * ( 2763.6 ) * 0.8763 * 5 = 3.6326$$

$${\dot{\hat{a}}}_{4} = {ζ}_{4} r {F}_{z} Sin ( 1 {λ}_{d , N} ) ⅇ = ( 0.001 ) * ( 0.3 ) * ( 2763.6 ) * 0.3681 * 5 = 1.5259$$

$${\dot{\hat{a}}}_{5} = {ζ}_{5} r {F}_{z} Sin ( 1 {λ}_{d , N} ) ⅇ = ( 0.001 ) * ( 0.3 ) * ( 2763.6 ) * ( - 0.3090 ) * 5 = - 1.2809$$

To update the coefficients, the processor may use an Euler integration technique from Equation (15).

$${a}_{j , new} = {a}_{j , old} + {\dot{\hat{a}}}_{j} * {T}_{s} \qquad ( 13 )$$

Placing the above values into Equation (15) provides the following equations and coefficients, where the sampling time is 0.005 seconds.

$${\dot{\hat{a}}}_{0 , new} = {\dot{\hat{a}}}_{0 , old} + {\dot{\hat{a}}}_{0} * T = 0 + 4.1454 * 0.005 = 0.0207$$

$${\dot{\hat{a}}}_{1 , new} = {\dot{\hat{a}}}_{1 , old} + {\dot{\hat{a}}}_{1} * T = 0 + 2.6423 * 0.005 = 0.0132$$

$${\dot{\hat{a}}}_{2 , new} = {\dot{\hat{a}}}_{2 , old} + {\dot{\hat{a}}}_{2} * T = 0 + 4.0720 * 0.005 = 0.0204$$

$${\dot{\hat{a}}}_{3 , new} = {\dot{\hat{a}}}_{3 , old} + {\dot{\hat{a}}}_{3} * T = 0 + 3.6326 * 0.005 = 0.0182$$

$${\dot{\hat{a}}}_{4 , new} = {\dot{\hat{a}}}_{4 , old} + {\dot{\hat{a}}}_{4} * T = 0 + 1.5259 * 0.005 = 0.0076$$

$${\dot{\hat{a}}}_{5 , new} = {\dot{\hat{a}}}_{5 , old} + {\dot{\hat{a}}}_{5} * T = 0 + ( - 1.2809 ) * 0.005 = - 0.0064$$

The processor then calculates the friction coefficient using the updated coefficients in Equation (12).

$${\hat{μ}}_{d} = {\hat{a}}_{0} + {\sum }_{j = 1}^{n} {a}_{j} Sin ( {jλ}_{d , N} ) \\ {\hat{μ}}_{d} = {\hat{a}}_{0} + {\hat{a}}_{1} Sin ( 1 {λ}_{d , N} ) + {\hat{a}}_{2} Sin ( 2 {λ}_{d , N} ) + {\hat{a}}_{3} Sin ( 3 {λ}_{d , N} ) + {\hat{a}}_{4} Sin ( 4 {λ}_{d , N} ) + {\hat{a}}_{5} Sin ( 5 {λ}_{d , N} ) \\ {\hat{μ}}_{d} = 0.0207 + 0.0132 * 0.6374 + 0.0204 * 0.9823 + 0.0182 * 0.8763 + 0.0076 * 0.3681 + ( - 0.0064 ) * ( - 0.3090 ) = 0.0699 \qquad ( 12 )$$

Therefore, the friction coefficient is estimated to be 0.0699. Each time the cycle is repeated, the estimation is more accurate due to the coefficients being updated.

Using the estimated friction coefficient, the torque to be applied to the wheel is calculated so that the wheel speed gets closer to the desired wheel speed for the next cycle. Assuming the inertia of the drive train to be 1 Kg−m² (I_{w}) and K₁=1, K₂=1, ρ=2, and desired wheel angular acceleration (\dot{ω}_{d})=5 rad/s², the torque may is calculated using Equation (16).
T=I_{w}\dot{ω}_{d}+r_{w}F_{zw}\hat{μ}_{d}(λ_{d})+K₁e+K₂ρ²e
T=1*5+(0.3)*2763.6*(0.0699)+1*5+1*(2)\hat{ }2*5=87.95 Nm (16)

Once the torque is calculated, it is then applied to the target wheel to help the vehicle reach the desired wheel speed or correct the yaw rate of the vehicle. This torque is applied to the wheel via an actuator (e.g. a motor) with the objective to reduce the wheel speed error (e). The cycle is then repeated from Step 101 (FIG. 3) using the new values, new accelerations, new velocities, and new coefficients, if necessary. The cycle may be repeated as often as needed. In the illustrated embodiment the cycle is repeated about fifty to one hundred forty times per second, currently the amount of cycles used by many vehicle control systems. It should be readily recognized that the more times per second the above method is repeated, generally the more accurate the friction coefficient will be.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

1. A method of estimating a friction coefficient between a driven wheel and a surface comprising:
receiving sensor readings indicative of a system state;
determining a desired wheel speed;
calculating a desired wheel slip ratio using said sensor readings and said desired wheel speed; and
using a Fourier series to estimate the friction coefficient.

2. The method of claim 1 further including the step of computing a wheel torque using said desired wheel speed, said sensor readings and said friction coefficient.

3. The method of claim 2 further including the step of applying said wheel torque to the driven wheel.

4. The method of claim 2 wherein said Fourier series includes coefficients, and wherein said step of using a Fourier series further includes the step of adjusting said coefficients.

5. The method of claim 1 wherein said desired wheel speed is determined from said sensor readings.

6. The method of claim 1 wherein said sensor readings include a wheel speed sensor reading and an accelerometer sensor reading.

7. A method of estimating a friction coefficient comprising:
receiving vehicle sensor readings indicative of a vehicle travel state;
estimating a velocity of the vehicle;
determining a desired wheel speed;
calculating a desired wheel slip ratio using said sensor readings and said desired wheel speed; and
estimating the friction coefficient through a Fourier series wherein said Fourier series uses said desired wheel slip ratio.

8. The method of claim 7 wherein said method is repeated and wherein said Fourier series includes coefficients, said coefficients being adjusted each cycle.

9. The method of claim 8 further including the step of calculating a torque adjustment based on the difference between an actual wheel speed and said desired wheel speed.

10. The method of claim 9 further including the step of applying the calculated torque to a vehicle wheel.

11. The method of claim 8 wherein said method is repeated at least approximately fifty times per second.

12. The method of claim 8 wherein said method is repeated at least approximately 140 times per second.

13. The method of claim 7 further including the step of calculating a wheel speed error and freezing said coefficients when said wheel speed error falls below a specified value.

14. A system for estimating a friction coefficient between a driven wheel of a vehicle and a surface, said system comprising:
a wheel speed sensor and an accelerometer each producing a signal; and
a processor communicating with said wheel speed sensor and accelerometer to receive said signals, said processor including
a first module estimating a velocity of the vehicle,
a second module determining a desired wheel speed,
a third module calculating a wheel slip ratio, said third module receiving said sensor readings and said desired wheel speed from said second module, and
a sixth module calculating the friction coefficient, said sixth module using a Fourier series in association with said desired wheel slip ratio to calculate the friction coefficient.

15. The system of claim 14 wherein said second module uses said signals in determining said desired wheel speed.

16. The system of claim 14 wherein said second module uses said estimated velocity in determining said desired wheel speed.
